(19) United States
(12) Patent Application Publication
(10) Pub. No.: US 2012/0235803 A1
(43) Pub. Date: Sep. 20, 2012

(54) SECURITY SYSTEM HAVING A VEHICLE GLASS BREAKAGE ALARM

(76) Inventor: Todd Bunting, Lexington, SC (US)

(21) Appl. No.: 13/052,085

(22) Filed: Mar. 20, 2011

(51) Int. Cl. B60R 25/10

(52) U.S. Cl. 340/426.27

(57) ABSTRACT

A home security system including vehicle glass breakage detection. A vehicle includes a glass breakage sensor and a wireless link to a home security system. The glass breakage sensor is configured and located in an unobtrusive manner within a vehicle. When the glass breakage sensor detects glass breakage it initiates a signal that causes the wireless link to inform the remainder of the home security system that the vehicle's glass has been broken. In response, the home security system notifies the home owner and a monitoring agency that the vehicle has been broken into.

### FIELD OF THE INVENTION

The presently disclosed subject matter is directed towards vehicle protection systems. More particularly, the present invention is directed to security systems having wirelessly connected vehicle glass breakage alarms.

### BACKGROUND OF THE INVENTION

As the economy declines property crimes tend to rise. In particular, vehicle break-ins have become a major problem faced everyday throughout the United States. Both residential and commercial neighborhoods are frequently targeted by both professional and amateur smash-and-grab vehicle vandals. While factory car alarms are ubiquitous, vehicle smash-and-grab vandals have discovered that they often can break into a parked vehicle and take what they want without being detected by simply breaking out a vehicle's window glass, crawling inside, taking what they want, and crawling back out. In fact many smash-and-grab vandals will not even open an unlocked door to prevent alarms from sounding but will break out the vehicle's glass and proceed as described above.

Compounding the problems of vehicle smash-and-grab theft is that many vehicle owners, particularly those in larger cities and apartment complexes lack either a garage or a garage space to park their vehicles in. Consequently, many vehicles are parked on the street or in open, unsecured lots. This creates a problem with standard vehicle alarms in that they are only effective if they are close enough to wake a vehicle owner. But, in many urban settings vehicle alarms go off so often that some people do not even react if they hear an alarm. Thus, even if a standard vehicle security system detects a vandal and sounds an alarm, that alarm is usually ignored and as such will not directly inform the vehicle's owner that his or her vehicle has been broken into.

Unfortunately neighborhoods targeted by smash-and-grab vandals tend to be ones having higher than average crime rates. Therefore, many vehicle owners have installed home security systems that sound alarms, both silent and audible, when a security incident such as smoke, fire, home break-in or other problem is detected. Glass breakage has also become a problem in homes. Over the years numerous methods of detecting glass breakage have been used. For example, the frequency of breaking glass will activate some sound sensors. Other broken glass sensors use have used infrared, ultrasound, or microwaves to detect spatial changes in the area being monitored, such as when a glass window opens or breaks. In such systems a quiescent state exists in the return of energy. When that state changes it is attributed to broken glass (or a door or window opening) and an alarm sounds.

Over the years home security systems have evolved into highly sophisticated devices that can be monitored by dedicated security agencies or by the police. After detection of a possible security event the monitoring agency or police perform a security check of the premises. However, that level of monitoring has generally not been applied to protect against vehicle smash-and-grab thefts. Thus vehicles have remained at least somewhat vulnerable.

As a result, a technique of sensing vehicle glass breakage in such a manner that a home owner is informed that his vehicle is being broken into would be beneficial. Also beneficial would be a technique of using a home security system to inform a vehicle owner that his vehicle has been broken. Also beneficial would be a technique of using a home security system to inform a monitoring agency or police department that a smash-and-gab vandal has broken into a vehicle by breaking glass.

### BRIEF SUMMARY OF THE INVENTION

The principles of the present invention provide for home security systems that include vehicle glass breakage detection. A home security system in accord with the principles of the present invention includes a vehicle glass breakage sensor tied to a wireless link between the vehicle glass breakage sensor and the remainder of the home security system. Beneficially the glass breakage sensor is configured and located in an unobtrusive manner in a vehicle. The glass breakage sensor and wireless link together form a monitored zone of the home security system. When the glass breakage sensor detects glass breakage it initiates a signal that causes the wireless link to inform the remainder of the home security system that the vehicle's glass has been broken. In response, the home security system notifies the home owner and possibly a monitoring agency that the vehicle has been broken into. The principles of the present invention are preferably incorporated in components that are either hidden from view or that blend into a vehicle's interior.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 illustrates a typical application of a home security system that is in accord with the principles of the present invention;

FIG. 2 depicts a home security system that is in accord with the principles of the present invention and that includes a vehicle glass breakage alarm as part of a protected zone; and

FIG. 3 depicts a vehicle having a glass breakage alarm and wireless link used in the home security system illustrated in FIG. 2.

### DETAILED DESCRIPTION OF THE INVENTION

The presently disclosed subject matter now will be described more fully hereinafter with reference to the accompanying drawings in which one embodiment of a home security system having remotely interconnected vehicle glass breakage detection is implemented. However, it should be understood that this invention may take many different forms and thus should not be construed as being limited to the specific embodiment set forth herein. In the figures like numbers refer to like elements throughout.

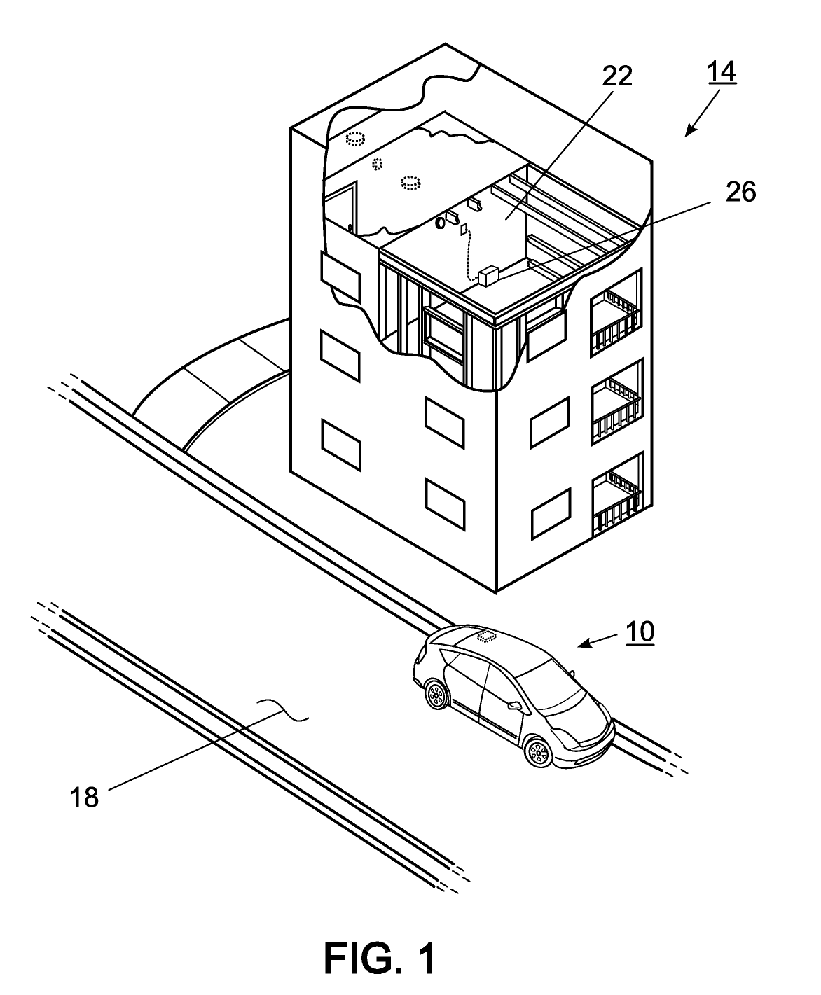

The principles of the present invention provide for a home security system having remote vehicle glass breakage detection such as that described herein with reference to FIGS. 1 to 3. FIG. 1 illustrates a typical application of the present invention. A vehicle owner owns a vehicle 10 which is parked away from his dwelling location, shown as an apartment building 14. The vehicle 10 is shown parked on a street 18, while the vehicle owner lives in an apartment 22. The vehicle owner does not necessarily have direct visual access to his vehicle 10 from his apartment 22. Furthermore, should an alarm in the vehicle 10 sound, the vehicle owner may not hear the alarm or, even if he does he may not know that it is his vehicle 10 that sounded the alarm. However, the vehicle owner has installed a home security system 26 that is in accord with the principles of the present invention.

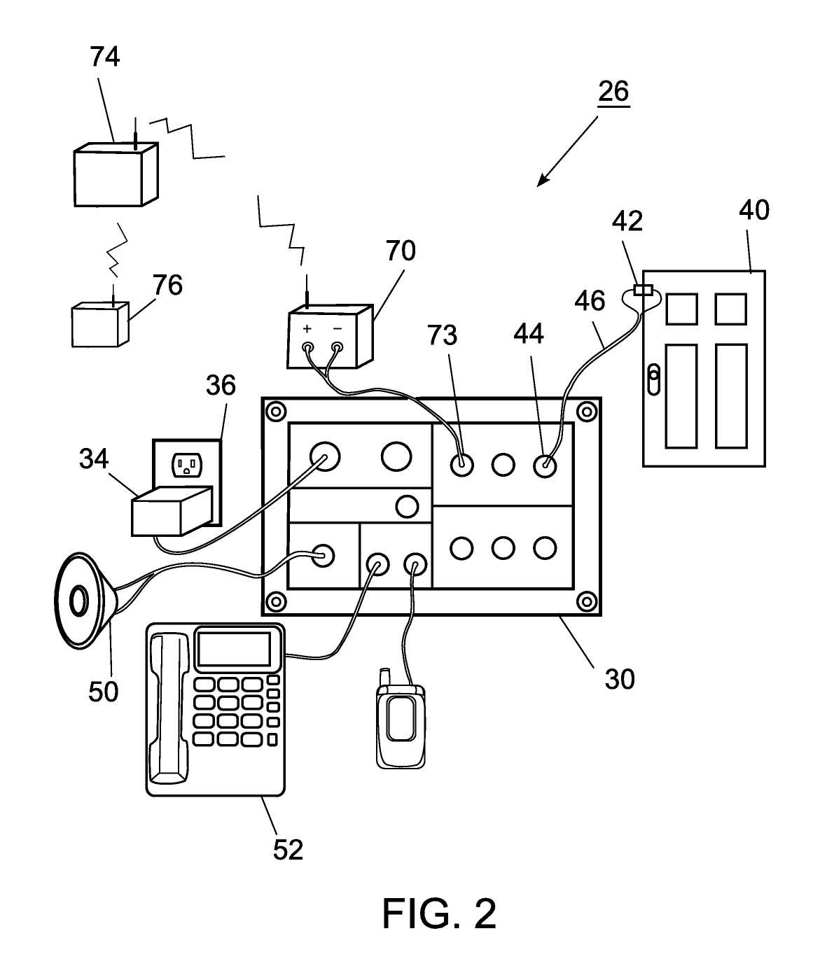

FIG. 2 illustrates the home security system 26 in more detail. As shown the home security system 26 includes a controller 30 that receives operational power from a power transformer 34 that connects to an AC power connector 36. As is common in the industry the controller 30 includes battery back-up which is not shown. The home security system 26 beneficially monitors other functions besides vehicle glass breakage. For example the home security system 26 is shown monitoring the opening of a door 40 using a magnetic sensor 42. Should the door 40 open, the magnetic sensor 42 would send a signal to the controller 30 via an input jack 44 and wiring 46. After some delay the controller 30 would sound an audible alarm 50 and would use a telephone connection 52 to inform a monitoring agency, either a private security monitoring agency or a police department, that a security incident has been detected. In response, the private monitoring agency or police department would ideally perform a security check on the premises. In addition, the controller 30 might dial another number, possibly via a cell phone 58, to inform an away owner that the security incident has occurred.

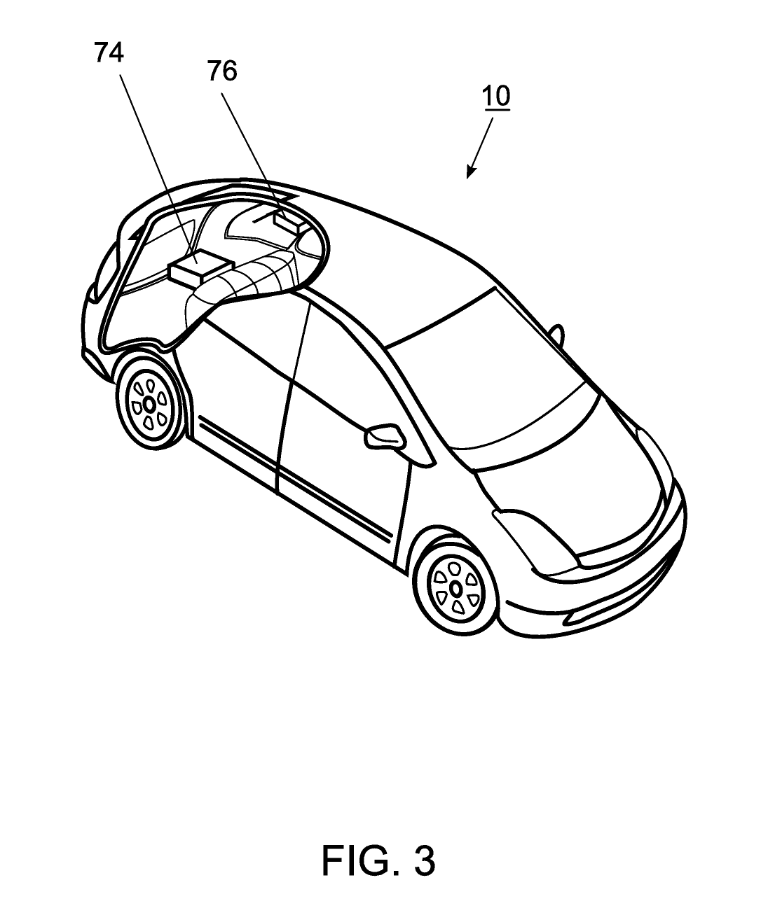

The foregoing are typical functions of prior art home security systems. However, the home security system 26 includes a vehicle glass breakage sensor that is remotely linked to the controller 30. To that end, a wireless link 70 inside the apartment 22 (referring back to FIG. 1) is connected to an input 73 of the controller 30. The wireless link 70 connects to a wireless transmitter 74 which is located in the vehicle 10, reference FIG. 3. Referring now to FIGS. 2 and 3, in turn, the wireless transmitter 74 is electronically connected to a glass breakage sensor 76 which is also located within the vehicle 10. The connection between the wireless transmitter 74 and the glass breakage sensor 76 is preferably via RF, but a wired connection or an ultrasonic connection is also possible (as is IR, microwave, or other energy transmissions).

When the glass breakage sensor 76 detects glass breakage, such as by a smash-and-grab vandal or possibly a tree branch or other object, the glass breakage sensor 76 sends a signal to the wireless transmitter 74 that glass breakage has occurred. In response, the wireless transmitter 74 sends a message to the wireless link 70 that glass breakage has occurred. In response, the wireless link 70 informs the controller 30 about the glass breakage. The controller 30 causes the audible alarm 50 to sound, and beneficially uses the telephone connection 52 to inform a monitoring agency, either a private security monitoring agency or a police department, that a glass breakage security incident has been detected. In response, the private monitoring agency or police department would ideally perform a security check on the vehicle 10. In addition, the controller 30 might dial another number, possible via a cell phone 58, to inform an away owner that glass breakage has occurred.

The glass breakage sensor 76 might be ultrasonic, IR, microwave, acoustic, or any other appropriate technology.

It is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A security system, comprising:
a controller for receiving one or more security incident signals that are indicative of an occurrence of a security incident, said controller further for generating an alarm signal in response to said one or more security incident signals;
an alarm response to said generated alarm signal, said alarm for notifying a user of the occurrence of a security incident;
a remote vehicle glass breakage sensor for producing a glass breakage signal when a vehicle's glass is broken;
a remote wireless link for receiving said glass breakage signal and for transmitting a glass breakage electromagnetic signal in response thereto; and
a receiver for receiving said glass breakage electromagnetic signal and for applying a security incident signal to said controller in response to said glass breakage electromagnetic signal.

2. The security system according to claim 1 wherein said glass breakage sensor is configured to be unobtrusive within a vehicle.

3. The security system according to claim 1 wherein said alarm notifies the home owner that a vehicle's glass is broken.

4. The security system according to claim 1 wherein said alarm notifies a security monitoring agency that a vehicle's glass is broken.

5. The security system according to claim 1 wherein said alarm notifies the police department that a vehicle's glass is broken.

6. The security system according to claim 1 wherein said controller dials a phone number when a vehicle's glass is broken.

7. The security system according to claim 1 wherein said remote vehicle glass breakage sensor uses sound frequency to detect glass breakage.

8. The security system according to claim 1 wherein said remote vehicle glass breakage sensor uses infrared signals to detect glass breakage.

9. The security system according to claim 1 wherein said remote vehicle glass breakage sensor uses microwave signals to detect glass breakage.

10. The security system according to claim 1 wherein said remote vehicle glass breakage sensor uses ultrasonic signals to detect glass breakage.
